(19) United States
(12) Patent Application Publication
(10) Pub. No.: US 2014/0014477 A1
(43) Pub. Date: Jan. 16, 2014

(54) CONVEYOR SYSTEM

(71) Applicant: Lee Michael Vine, Dorset (GB)

(72) Inventor: Lee Michael Vine, Dorset (GB)

(73) Assignee: ISHIDA EUROPE LIMITED, West Midlands (GB)

(21) Appl. No.: 14/008,199

(22) PCT Filed: Apr. 20, 2012
(86) PCT No.: PCT/GB2012/050864

§ 371 Date: Sep. 27, 2013

(30) Foreign Application Priority Data
Apr. 21, 2011 (GB) 1106704.8

(51) Int. Cl. B65G 15/12

(52) U.S. Cl. CPC B65G 15/12
USPC 198/698

(57) ABSTRACT

A conveyor system for conveying articles is provided, comprising a plurality of indexing flights (4) rotatably coupled to and spaced along a conveyor, wherein each of the plurality of indexing flights has a first laterally protruding guiding member (7) and a second laterally protruding guiding member (8); first and second grooves (20,21) laterally spaced from said conveyor and arranged to receive said first and second guiding members respectively; and adjustment means (19) for adjusting, in use, the first protruding member (7) of each flight to a leading or trailing position with respect to its second protruding member (8) such that each flight (4) is positioned either to a protruding position or to a retracted position with respect to the conveyor.

This invention relates to a variable pitch infeed conveyor for use, for example, for feeding articles such as trays in a tray sealing system. Such a tray sealing system will typically comprise an infeed conveyor, a tray sealing machine and an output conveyor. Trays to be sealed are fed to the tray sealing machine on the infeed conveyor, and removed on the outfeed conveyor.

Infeed conveyors for feeding tray sealing machines typically come in two main forms: flat belt conveyors or a chain with indexing flights. In the case of flat belt conveyors the trays are non-uniformly spaced along the length of the conveyor, and these conveyors are typically used where product is manually placed into the trays. The product is generally a food item, although the trays may be used to contain other items.

A belt or chain with indexing flights is typically used where automatic filling of the trays is required. The flights are used to keep the trays at a known spacing, or pitch, along the length of the conveyor, and this allows for the correct timing between the filling system and the tray. Here the filling system is typically a system for filling the trays with food items.

Such filling systems are typically used in one of two ways: indexing motion or continuous motion. Where indexing motion is used the trays are positioned under the filling system either one at a time or in pairs and are indexed at one or two pitches respectively. Continuous motion is typically used where high throughputs are required which does not allow sufficient time to arrest and accelerate the trays without the product becoming displaced within the tray.

When using a conveyor with indexing flights, the spacing, or pitch, between the flights must be sufficient to accommodate the largest tray to be run through the tray sealing machine. However, many tray sealing machines will frequently be changed to run trays of differing sizes. When running a small tray (as compared to a larger tray) the tray sealing machine has a greater capacity and is capable of processing trays at a higher rate. However, due to the fixed spacing between the flights, the increase in throughput of the small trays requires the conveyor to be run at substantially higher speed than is optimal. This higher speed compromises the stability of the tray and any filling operations performed along the length of the line.

There are two main ways to avoid this compromised situation, the entire chain or belt can be exchanged for another one with suitable flight spacing or another complete line is used to run the other tray size. This increases downtime of the system, thus reducing efficiency and output.

This problem has been addressed in patent application WO 97/23386. This document discloses a packaging machine with a conveyor chain that includes spaced pop-up lugs selectively reciprocated from lowered positions to raised positions extending along the conveyor chain for varying the pitch. However, the mechanism for doing this comprises two separate channels along which a peg on the pop-up lug can travel, corresponding to either the reciprocated or lowered positions. Forcing a peg into a particular channel has disadvantages including lower operating speed—reducing throughput—and the possibility of mechanical jams.

In accordance with a first aspect of the present invention there is provided A conveyor system for conveying articles, comprising; a plurality of indexing flights rotatably coupled to and spaced along a conveyor, wherein each of the plurality of indexing flights has a first laterally protruding guiding member and a second laterally protruding guiding member; first and second grooves laterally spaced from said conveyor and arranged to receive said first and second guiding members respectively; and adjustment means for adjusting, in use, the first protruding member of each flight to a leading or trailing position with respect to its second protruding member such that each flight is positioned either to a protruding position or to a retracted position with respect to the conveyor.

Preferably the conveyor is an endless conveyor such as an endless chain.

In a preferred embodiment there is a plurality of indexing flights coupled to and spaced along a chain, where the flights are coupled to extended chain pins. This solution advantageously enables the pitch between indexing flights to be set as desired in order to optimise throughput and conveyor speed for the size of tray being worked.

In a preferred embodiment the first and second grooves are located on a moveable cam laterally spaced from the conveyor, said adjustment means comprising a control system for moving the cam between first and second positions with respect to the conveyor. In this embodiment, when the cam is in the first position, the first protruding member of each flight engages a first surface of the first groove such that, in use, each flights rotate in a first direction about its first protruding member; and when the cam is in the second position, the first protruding member of each flight engages a second surface of the first groove such that, in use, each flight rotates in a second direction about its first protruding member.

With the adjustment means according to the abovementioned embodiment of the invention, the cam only needs to move a small amount in order to position the flights accordingly. In one embodiment the cam is moved along the axis of the conveyor. Further, the first and second protruding members are contained within their own individual grooves and so there is no requirement for forcing a peg into a one of a number of channels, as in the prior art. This means that the infeed conveyor of the present invention can run at higher speeds, up to 22.5 m/minute and without the risk of a mechanical jam. This increases throughput and reduces downtime of a tray sealing system employing an infeed conveyor of the present invention. It also increases operator safety.

In one embodiment of the present invention, the second groove defines a path shorter than the first groove.

In a preferred embodiment, the conveyor is an endless chain engaging with a drive sprocket and an idler sprocket and the moveable cam is laterally spaced from the idler sprocket.

Preferably, the control system is a pneumatic drive system which is advantageously suited to the small amount of movement required by the movable cam. However, other control systems may be used, such as a servo motor.

Other adjustment means are envisaged, for example magnets for adjusting the first protruding member of each flight to a leading or trailing position with respect to its second protruding member such that each flight is positioned in either a protruding position or a retracted position with respect to the conveyor. In another example, a control apparatus for directing pressurised gas towards the flights so as to adjust the first protruding member of each flight to a leading or trailing position with respect to its second protruding member such that each flight is positioned in either a protruding position or a retracted position with respect to the conveyor is provided.

Preferably, the second groove extends laterally from the first groove, and the first and second guiding members laterally protrude different lengths from the flights such that only the second protruding member engages with the second groove.

This advantageously decreases the likelihood of a mechanical jam, since in the event of a machine failure, the guiding members will continue to move in their own grooves rather than becoming jammed.

In another preferred embodiment, the first guiding member of each flight has a substantially circular cross section and further comprises an O-ring. This advantageously provides more friction between the first guiding member and the first or second surface of the first groove so as to provide ease of rotation of the flights.

Preferably, the conveyor system further comprises a tray guide located along the conveyor for supporting an article being conveyed.

In a preferred embodiment, the tray guide has third and fourth grooves for receiving the first and second guiding members respectively, wherein the fourth groove laterally extends from the third groove and the third and fourth grooves cooperate with the first and second grooves respectively. Preferably, the third and fourth grooves each define a path parallel to the conveyor. This advantageously ensures that the first and second guiding members are urged along paths parallel to the tray guide, therefore maintaining the flights in either a protruding or retracted position with respect to the tray guide and allowing the protruding flights to act against an article.

In one embodiment the conveyor system further comprises a static cam laterally adjacent the conveyor having fifth and sixth grooves for receiving the first and second guiding members respectively, wherein the sixth groove extends laterally from the fifth groove and wherein the fifth and sixth grooves cooperate with the third and fourth grooves respectively. Preferably, the sixth groove defines a path shorter than the fifth groove.

In a preferred embodiment the conveyor is an endless chain engaging with a drive sprocket and an idler sprocket and the static cam is laterally spaced from the drive sprocket. Advantageously, as the protruding flights travels around the drive sprocket on the chain, this prevents the flights from accelerating harshly which could spill contents of the tray.

In a preferred embodiment the third and fifth grooves define a single continuous groove and the fourth and sixth grooves define a single continuous groove in order to further reduce the likelihood of a mechanical jam.

In a preferred embodiment the indexing flights each have a curved portion for travelling around corners. Thus, in a preferred embodiment the pin joints of the chain allow a degree of sideways movement, this sideways movement of the chain allows it to follow a curved path. Therefore the guides and the guiding grooves may define both straight and curved sections and allow greater flexibility in conveyor design. This is advantageous where conveyors are required to fit around existing equipment in an existing factory. In this embodiment the flights have sufficient clearance between themselves and the chain to allow side flexing with contact between their surfaces.

Embodiments of the present invention will now be compared and contrasted with the prior art with reference to the following drawings in which:

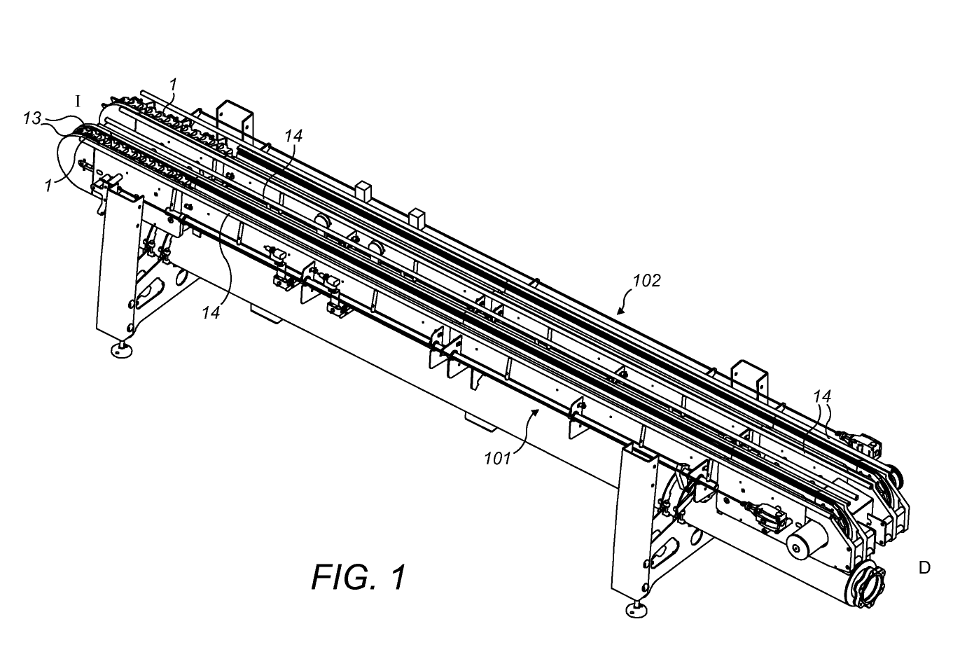

FIG. 1 shows a perspective view of two conveyors according to one embodiment of the invention;

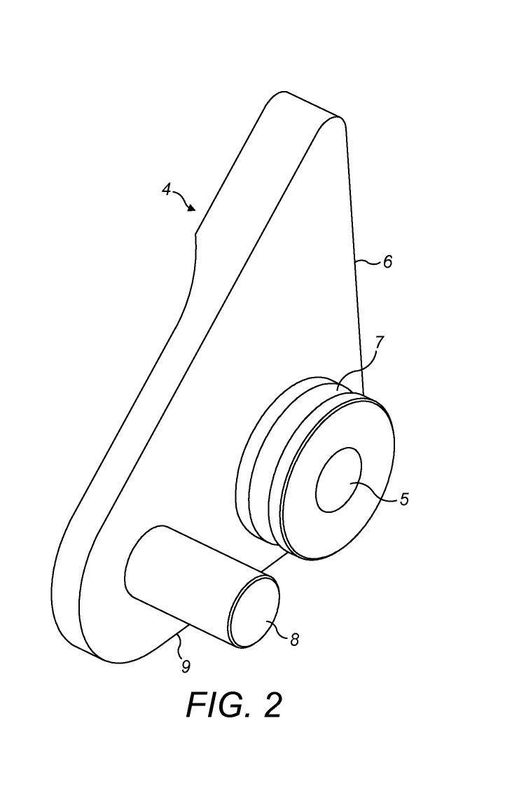

FIG. 2 is a perspective view of an indexing flight according to one embodiment of the invention;

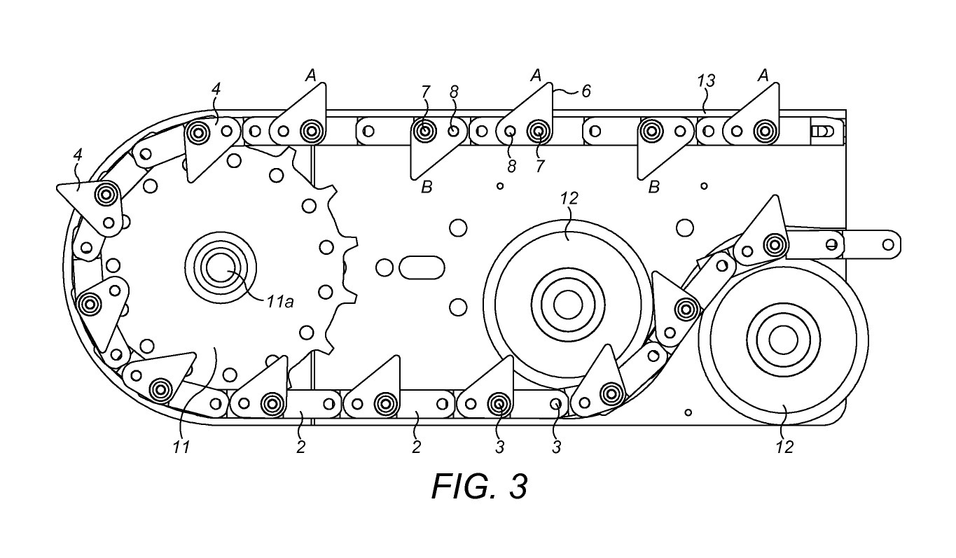

FIG. 3 is a schematic view of the idler end of the conveyor showing the switching of the indexing flight position according to one embodiment of the invention;

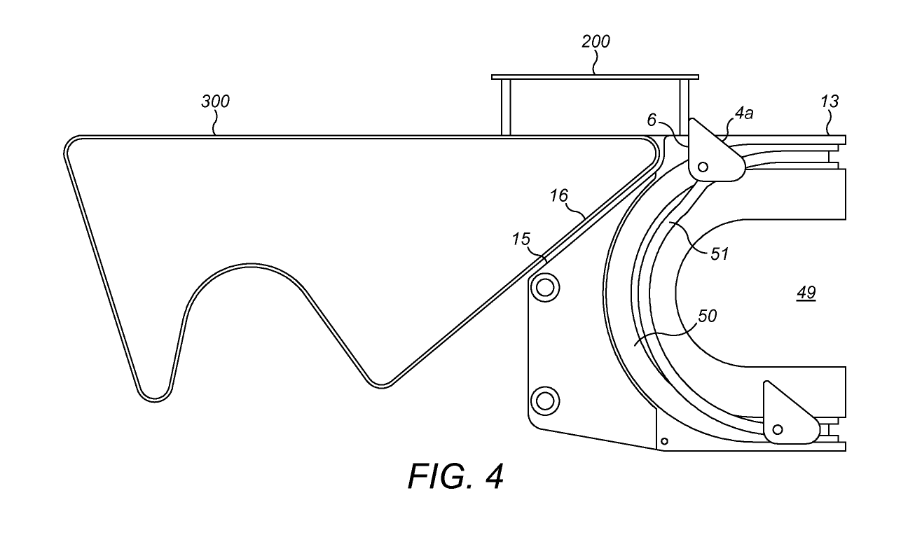

FIG. 4 is a schematic view of the drive end of a conveyor system according to one embodiment of the invention;

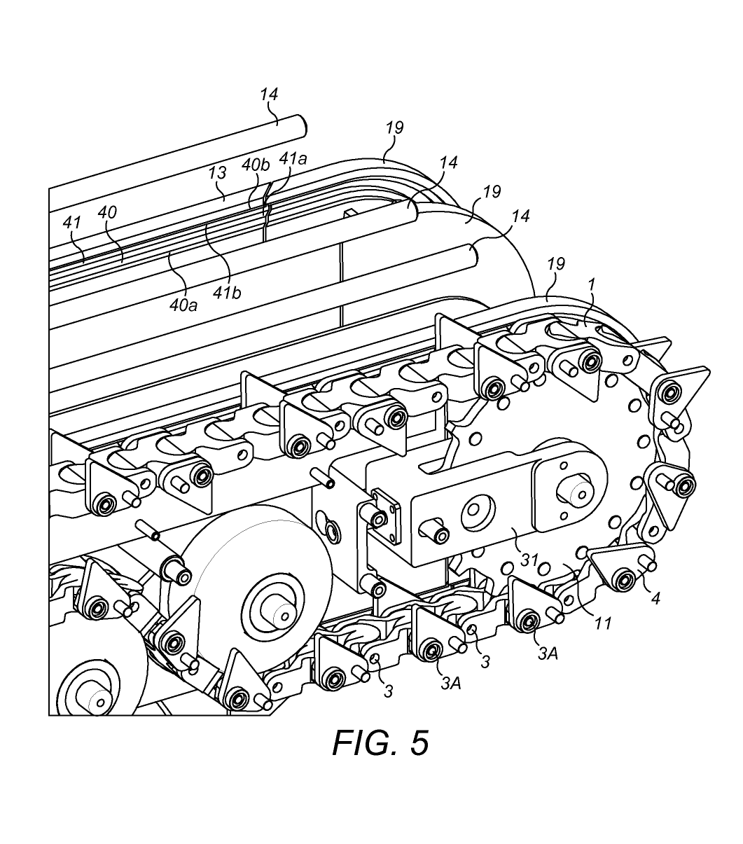

FIG. 5 is a cutaway perspective view of the idler end of a conveyor system according to one embodiment of the invention;

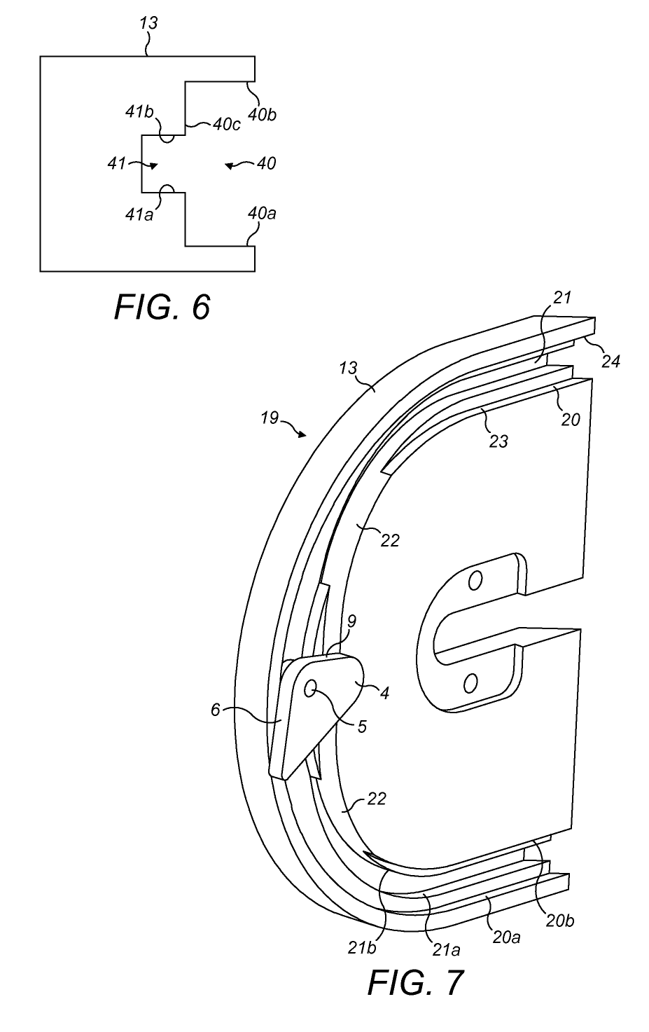

FIG. 6 is a cross-sectional view of the grooves within the tray guide according to one embodiment of the invention;

FIG. 7 is a cutaway perspective view of the movable cam of a conveyor system according to one embodiment of the invention;

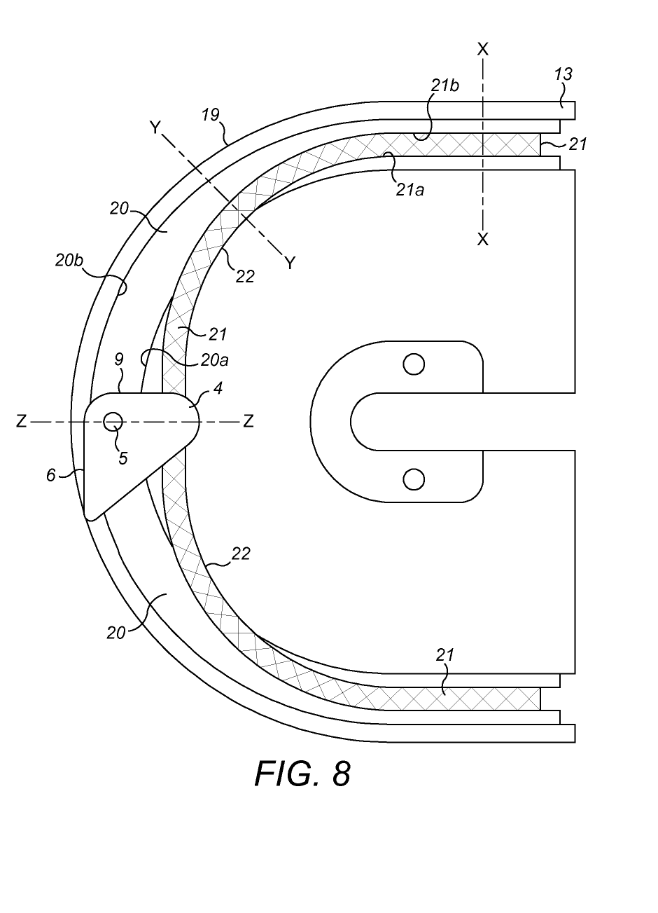

FIG. 8 is a side-on schematic view of the moveable cam of a conveyor system according to one embodiment of the invention;

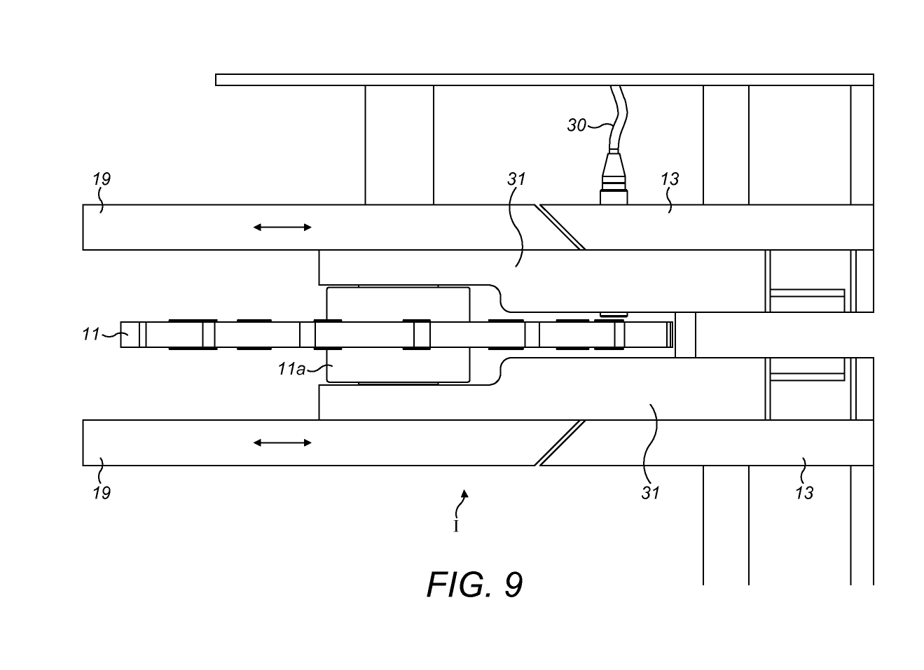

FIG. 9 is a plan view of the idler sprocket and moveable cam of a conveyor system according to one embodiment of the invention;

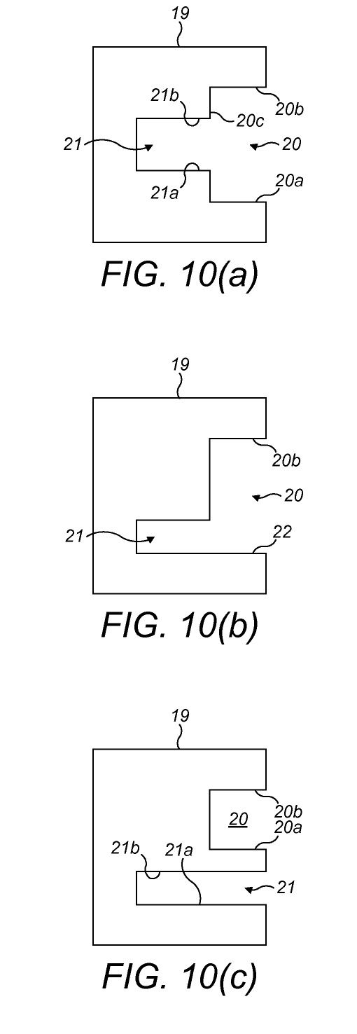

FIG. 10(a) is a cross-sectional view of the grooves within the moveable cam according to one embodiment of the invention;

FIG. 10(b) is a further cross-sectional view of the grooves within the moveable cam according to one embodiment of the invention;

FIG. 10(c) is a further cross-sectional view of the grooves within the moveable cam according to one embodiment of the invention;

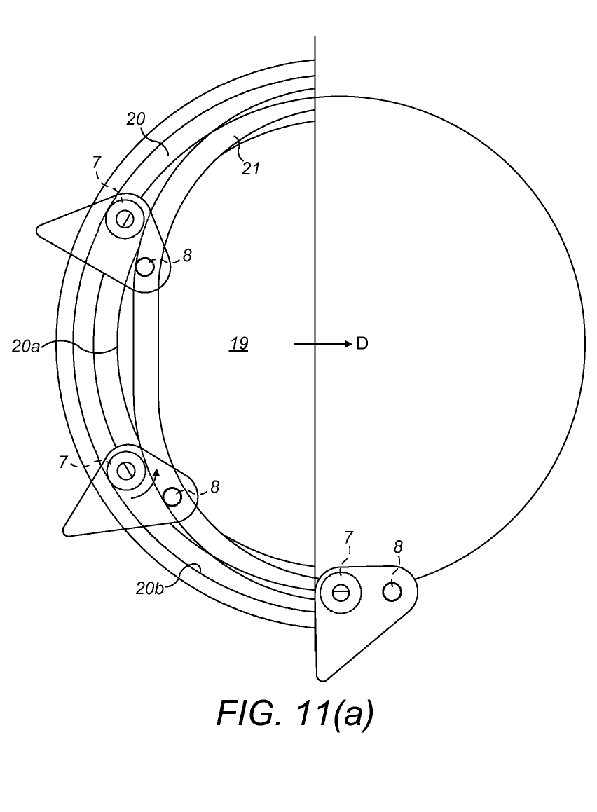

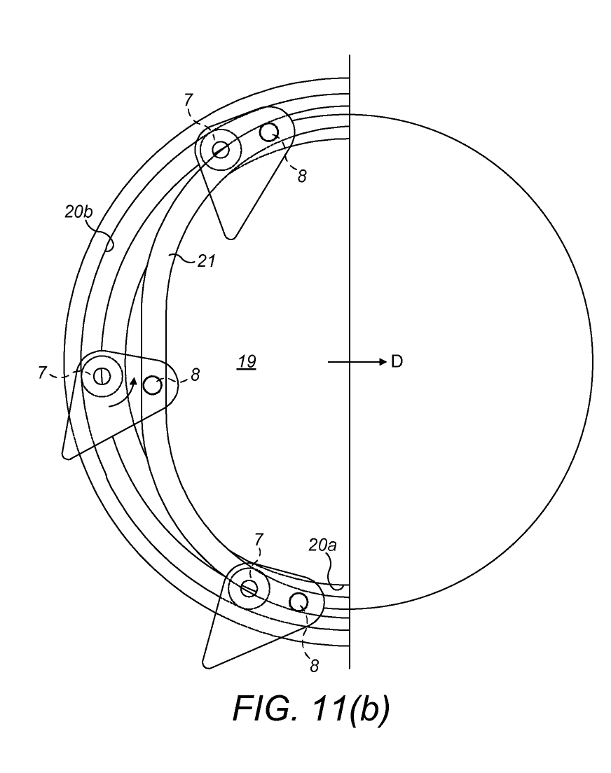

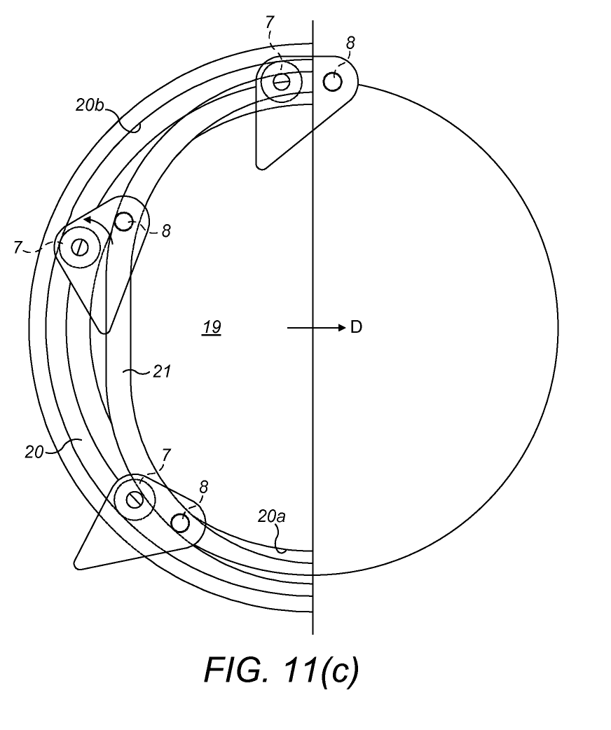

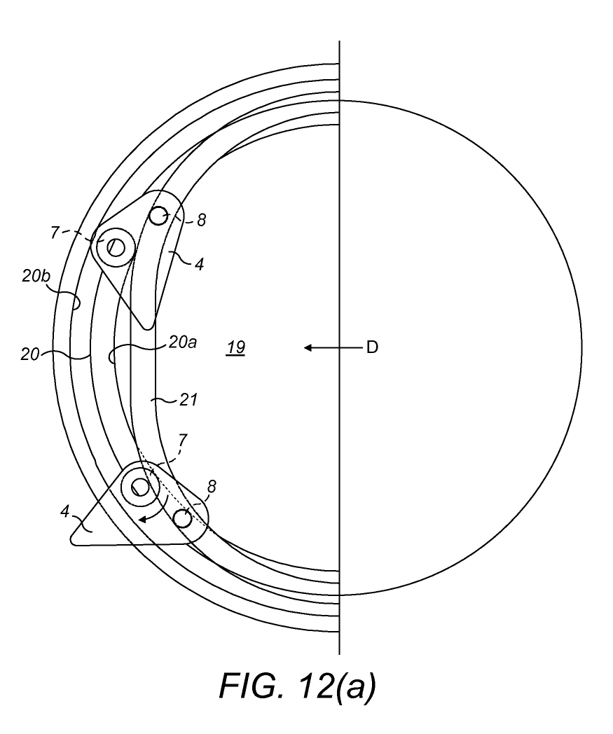

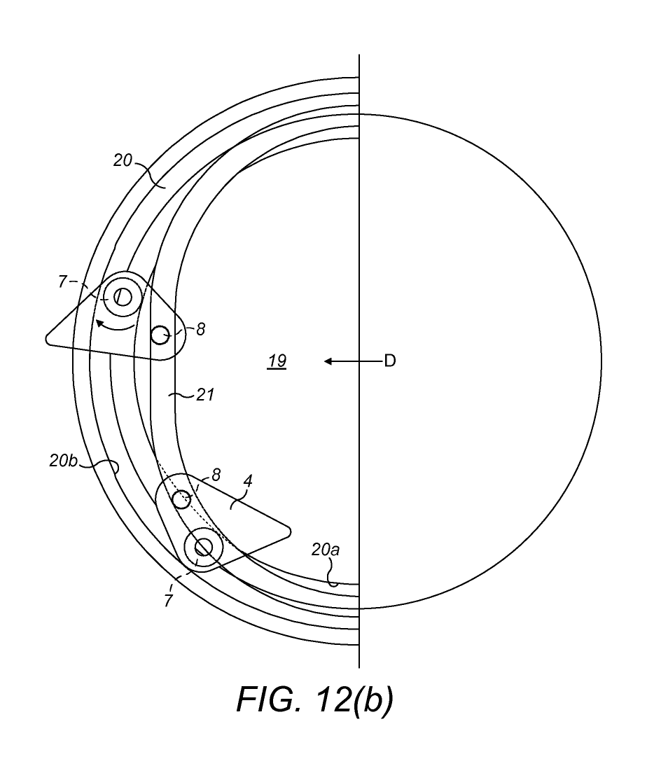

FIG. 11(a) is a diagram showing the positioning of an indexing flight towards a retracted position;

FIG. 11(b) is a further diagram showing the positioning of an indexing flight towards a retracted position;

FIG. 11(c) is a further diagram showing the positioning of an indexing flight towards a retracted position;

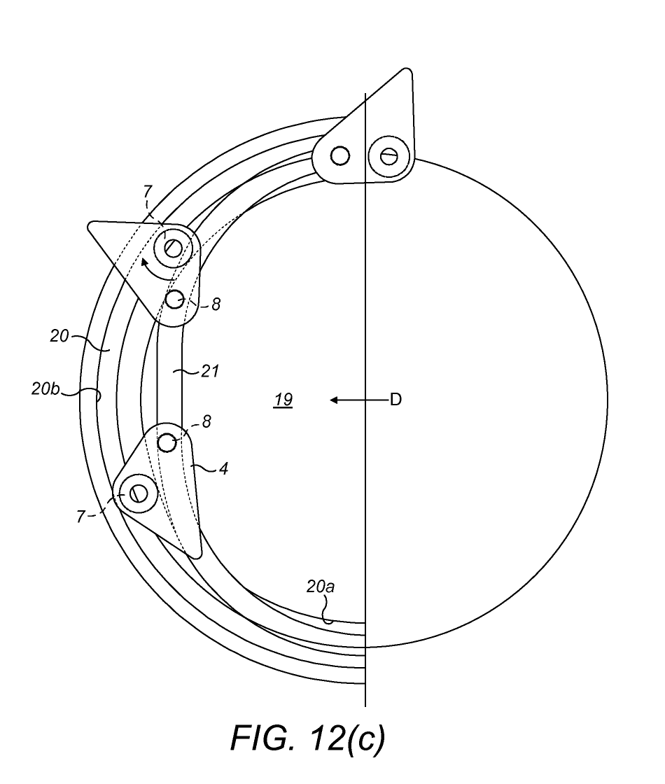

FIG. 12(a) is a diagram showing the positioning of an indexing flight towards a protruding position;

FIG. 12(b) is a further diagram showing the positioning of an indexing flight towards a protruding position; and

FIG. 12(c) is a further diagram showing the positioning of an indexing flight towards a protruding position.

In the following description, relative directional terms such as “clockwise” and “anti-clockwise” are used for ease of understanding and are not intended to be limiting.

Considering first FIG. 1, a perspective view of two infeed conveyors 101, 102 according to one embodiment of the invention is shown. This Figure shows two infeed conveyors laterally spaced, however there may be only one conveyor or more than two conveyors. In the following description, one infeed conveyor 101 will be described for ease of understanding.

In one embodiment the conveyor 101 comprises an endless chain 1 with a plurality of indexing flights 4 rotatably coupled to and spaced along the chain 1. The chain 1 comprises a plurality of links 2 coupled together with chain pins 3. In a particular embodiment some of the chain pins 3, indicated at 3A (see FIG. 5), are extended laterally to protrude from the chain links 2 such that an indexing flight 4 may be coupled to the pin via coupling hole 5 (see FIG. 2). In one embodiment the indexing flights 4 are coupled in a regular arrangement to every second chain pin 3, although other spacing arrangements are envisaged.

The flights 4 are free to rotate about the chain pin 3 and are secured against lateral movement by a circlip (not shown). Preferably, the chain pins 3A extend from both sides of the chain 1 and are coupled to two indexing flights 4 as seen clearly in FIG. 5, although only one flight 4 may be coupled to a chain pin 3.

FIG. 2 shows a perspective view of an indexing flight 4. The flight has a substantially right-angled triangular shape with a straight pushing edge 6 for pushing trays along the tray guide 13, although other shapes are envisaged such as a rectangular shape.

The endless chain 1 is routed around a drive sprocket (not shown) and an idler sprocket 11, as seen in FIG. 3. The drive sprocket is located at the drive end D of the conveyor and the idler sprocket 11 is located at the idler end I of the conveyor. The distance between the sprockets depends upon the length of the conveyor and is determined by the production process required. In one embodiment rollers 12 are employed to ensure optimal routing and tension of the chain, as seen in FIG. 3.

Referring to FIGS. 1 and 5, trays to be sealed (not shown) are supported by tray guides 13 and pushed by indexing flights 4 at the desired pitch. Guide rails 14 ensure the trays move along the desired path.

As described above, flight 4 comprises coupling hole 5 for coupling to extended chain pin 3. Surrounding the coupling hole 5 and concentric to it is an annulus-shaped drive roller 7 protruding laterally from one face of the flight. In one embodiment the drive roller 7 comprises a groove 7a extending around the circumference of the drive roller 7 and a rubber O-ring (not shown) fits into the groove 7a. In another embodiment according to the invention the drive roller 7 does not have a groove.

A substantially cylindrical location peg 8 protrudes laterally from the same face of the indexing flight 4. In one embodiment the location peg 8 laterally protrudes further from the face of the flight 4 than the drive roller 7; however, the drive roller 7 may protrude further than location peg 8. In a preferred embodiment a line drawn through the axes of the location peg 8 and the coupling hole 5 is parallel to the edge 9 of the indexing flight 4, although other arrangements are envisaged. The peg is preferably cylindrically shaped, although other shapes are envisaged.

FIG. 3 shows a schematic of the idler end I of the conveyor 101. The chain 1 moves around the path defined by the idler sprocket 11, which is rotatable about axle 11a. In this Figure the chain moves clockwise such that the flights 4 are either in a protruding position A with respect to the tray guide 13, or a retracted position B with respect to the tray guide. In position A, pushing face 6 of the protruding indexing flights 4 contacts the trays on the tray guide 13 in order to move the trays along the conveyor. By controlling which flights 4 are in a protruding position A and which flights are in a retracted position B, the pitch between the trays to be sealed can be varied as desired.

As can be seen in FIG. 3, when an indexing flight 4 is in the protruding position A the drive roller 7 leads the location peg 8 in the direction of motion. When the indexing flight is in the retracted position, the drive roller 7 trails the location peg 8.

FIG. 4 shows the drive end D of an infeed conveyor 101 according to an embodiment of the present invention. The drive sprocket is omitted for purposes of clarity. In a particular example, the infeed conveyor 101 is adjacent another module 300 of a tray sealing system. This module 300 may be a tray sealing machine or a further conveyor. As seen in FIG. 4, in one embodiment, the drive end D of the infeed conveyor has a cutaway section 15 for improved fitting with the shaped portion 16 of the module 300.

In the view of FIG. 4 the flights 4 move anti-clockwise around the drive sprocket. Flight 4a is in the protruding position and cooperates with tray 200 at pushing edge 6 in order to move the tray along the tray guide 13 and onto module 300.

As seen in FIG. 5, the tray guide 13 comprises two grooves 40 and 41 for receiving the drive roller 7 and the location peg 8 respectively. FIG. 6 depicts a cross section of the grooves 40 and 41. Groove 40 comprises opposing faces 40a and 40b and groove 41 comprises opposing faces 41a and 41b. Groove 41 laterally extends from the base 40C of groove 40 as seen in FIG. 6, such that groove 41 is recessed further in the tray guide than groove 40. The distance between opposing faces 41a and 41b is smaller then the gap between faces 40a and 40b such that groove 41 has a smaller width than groove 40. The location peg 8 engaging with groove 41 prevents the flight 4 from rotating about the chain pin 3 and allows pushing face 6 to act against the tray.

When the flight reaches the drive sprocket it is transferred to cam 49 which comprises grooves 50 and 51 (see FIG. 4) aligned with grooves 40 and 41 respectively, for receiving the drive roller 7 and the location peg 8 respectively. The groove 51 defines a shorter path through the cam than groove 50 and guides the peg to ensure that that the pushing edge 6 remains perpendicular to the tray guide 13 whilst the pushing face 6 is in contact with the tray. Advantageously, this ensures a smooth transfer of the tray off the infeed conveyor and onto module 300. In contrast, in prior art systems with fixed indexing flights, the flights typically accelerate when following the path defined by the drive sprocket, which can lead to undesirable spillage of tray contents.

Groove 51 guides peg 8 so that all flights are retracted with respect to the lower surface of guide 13. This has the advantage of removing any safety hazards from the underside of guide 13, as all the flights are retracted within the dimensions of the guide 13 as they return along the conveyor.

At the idler end of the conveyor 101, the flights 4 are transferred to cam 19 (see FIG. 5). Here, the indexing flights 4 are guided by two grooves 20 and 21 aligned with grooves 40 and 41 respectively. Drive roller 7 engages with groove 20 and location peg 8 engages with groove 21.

Whereas cam 49 is a static cam, cam 19 is horizontally movable along the axis of the conveyor 101 and it is this movement that determines whether the flights 4 are in a protruding or retracted position with respect to the tray guide 13. This adjustment means is explained below.

FIGS. 7 and 8 show perspective and side-on views, respectively, of cam 19. FIG. 9 shows a plan view of the idler end I of conveyor 101, showing the positioning of said cam 19. As can be seen in FIG. 9, cam 19 is laterally spaced from the idler sprocket 11. In an embodiment shown, where the chain 1 has indexing flights 4 on both sides, there are two cams 19, one located on each side of the idler sprocket 11. In an embodiment where the chain 1 only has indexing flights on one side, there is only the requirement for one cam 19. The cam is linked via arms 31 to control system 30 which is operable to move the cam horizontally along the axis of the conveyor 101. Preferably control system 30 is a pneumatic drive although other means of moving the cam are envisaged, such as a servo motor.

The cam 19 contains two grooves 20 and 21. Groove 21 comprises opposed surfaces 21a and 21b and extends from the base 20C of groove 20 as seen in FIG. 7. Groove 21 extends laterally from groove 20 such that groove 21 is further recessed into the cam 19 than groove 21. Groove 20 comprises surfaces 20a and 20b and has a greater width (distance between its two opposing surfaces) than groove 21. Location peg 8 engages with groove 21 and drive roller 7 engages with groove 20. As explained hereinabove, in one embodiment the location peg 8 extends laterally further from the flight 4 than drive roller 7. As seen in FIG. 2, the radius of the location peg 8 is smaller than that of the drive roller 7. This ensures that drive roller 7 only engages with groove 20, and location peg 8 only engages with groove 21. In a different embodiment, drive roller 7 has a smaller radius and extends further than location peg 8, such that drive roller 7 only engages with groove 21 and location peg 8 only engages with groove 20.

In the view of both FIGS. 7 and 8 the indexing flight 4 is moving anti-clockwise. At the top and bottom of the cam 19, the grooves 20 and 21 run along parallel paths to align with the grooves 40 and 41 on tray guide 13. Groove 21 defines a shorter path through the cam 19 than groove 20, and so the grooves 20 and 21 share a common surface 22 at two places in the cam. FIGS. 10(a), 10(b) and 10(c) show cross sections of the relative positions of grooves 20 and 21 through the cam along X-X (FIG. 10(a)), Y-Y (FIG. 10(b)) and Z-Z (FIG. 10(c)).

In FIGS. 7 and 8 the indexing flight is shown with neither the drive roller 7 nor the location peg 8 leading. This is known as the “neutral” position of the indexing flight 4. From this position, movement of the cam 19 controlled by control system 30 adjusts the flight 4 such that either the drive roller 7 leads the location peg 8 (such that the flight is in a protruding position when moving along the tray guide 13) or the drive roller 7 trails the location peg 8 (such that the flight is in a retracted position when moving along the tray guide 13).

The adjustment means for adjusting the flights 4 into the desired position will now be described with reference to the following drawings. FIGS. 11(a), 11(b) and 11(c) outline the adjustment means for ensuring the location peg 8 leads the drive roller 7 and that the flight is subsequently in the retracted position when moving along the tray guide 13 of the infeed conveyor 101. Here the control system 30 moves the cam towards the drive end D of the infeed conveyor 101 along the axis of the infeed conveyor. The chain tension around the drive and idler sprockets remains constant and thus the drive roller 7 of the indexing flight 4 engages with the outer surface 20b of groove 20. The groove 20 has a width slightly wider than the drive roller diameter such that the drive roller 7 is now only in contact with the outer surface 20b of groove 7 and is not in contact with the inner surface 20a. Similarly, the groove 21 has a width slightly wider than the location peg diameter such that the location peg 8 is able to move freely.

The indexing flight 4 is driven around the idler sprocket on the chain 1. As the flight is rotatably mounted to the chain pin 3 and the drive roller 7 is engaged only with surface 20b, the flight 4 rotates anti-clockwise about the drive roller 7 such that the location peg 8 leads the drive roller 7 and the flight moves along the tray guide 13 in a retracted position. This sequence is seen in FIGS. 11(a), 11(b) and 11(c).

FIGS. 12(a), 12(b) and 12(c) show the sequence where the flight 4 is positioned such that the drive roller 7 leads location peg 8 and the flight is in a protruding position for moving along the tray guide 13.

In this case the drive system moves the cam towards the idler end of the conveyor 101. The chain tension around the drive and idler 11 sprockets remains constant and thus the drive roller 7 of the index flight 4 engages with the inner surface 20a of groove 20. The groove 20 has a width slightly wider than the drive roller diameter such that the drive roller 7 is now only in contact with the inner surface 20a of groove 7 and is not in contact with the outer surface 20b. Similarly, the groove 21 has a width slightly wider than the location peg diameter such that the location peg 8 is able to move freely.

The index flight 4 is driven around the idler sprocket on the chain 1. As the flight is rotatably mounted to the chain pin 3 and the drive roller 7 is engaged only with surface 20a, the flight 4 rotates clockwise about the drive roller 7 such that the location peg 8 trails the drive roller 7 and the flight moves along the conveyor in a protruding position. This sequence is seen in FIGS. 12(a), 12(b) and 12(c).

The fact that the indexing flights 4 are adjusted at the idler end of the infeed conveyor advantageously ensures that the flights 4 are at the correct pitch for the entire length of said conveyor.

In one embodiment the drive roller 7 has a groove 7a extending around its circumference. In one embodiment a rubber O-ring is placed in the groove 7a to advantageously increase friction between the surfaces of the groove 21 and the drive roller.

The “working angle” defines the length of groove surface 20a, 20b that the drive roller 7 needs to contact in order for the flight to be adjusted accordingly. For this adjustment means described above, the working angle is approximately 30° either side of the neutral position. Advantageously, this means that even though several flights 4 may be moving around the cam 19 at the same time, each flight can be individually adjusted. This gives the greatest degree of control over the flight spacing.

The grooves 20 and 21 align with grooves 40 and 41 on the tray guide which in turn align with grooves 50 and 51 on the drive end cam 49. Therefore the location peg 8 and the drive roller 7 are constantly engaged with their respective grooves. This advantageously reduces the risk of mechanical failure, since if the adjustment means fails, the location peg 8 and drive roller 7 will merely continue to be guided in their respective grooves. This is in contrast to prior art systems where pegs are required to be forced into specific grooves and failure to do so can cause mechanical failure, decreasing efficiency and increasing cost.

Further, the reduced risk of mechanical failure together with the very small amount of movement required by the cam, approximately 2 mm, means that high conveyor speeds up to 22.5 m/minute can be attained. This advantageously increases throughput.

Although the above description describes a movable cam for adjusting the indexing flights, other means of adjusting the flights are envisaged, for example an air blast of the use of magnets to manipulate the flight such that the drive roller 7 is either leading or trailing the location peg 8 as necessary.

Although the above-described embodiments relate to the use of an infeed conveyor in relation to a tray sealing system, the infeed conveyor of the present invention can be used in other situations such as at a construction site. Similarly, the above-mentioned embodiments refer to the use of a chain, although other means of driving the conveyor are envisaged, such as belts and the like could be used.

1. (canceled)

2. A conveyor system for conveying articles, comprising;
a plurality of indexing flights rotatably coupled to and spaced along a conveyor, wherein each of the plurality of indexing flights has a first laterally protruding guiding member and a second laterally protruding guiding member;
first and second grooves laterally spaced from said conveyor and arranged to receive said first and second guiding members respectively; and
adjustment means for adjusting, in use, the first protruding member of each flight to a leading or trailing position with respect to its second protruding member such that each flight is positioned either to a protruding position or to a retracted position with respect to the conveyor, wherein the first and second grooves are located on a moveable cam laterally spaced from the conveyor, said adjustment means comprising a control system for moving the cam between first and second positions with respect to the conveyor.

3. The conveyor system of claim 2, wherein the cam is movable along the axis of the conveyor.

4. The conveyor system of claim 2, wherein when the cam is in the first position, the first protruding member of each flight engages a first surface of the first groove such that, in use, each flight rotates in a first direction about its first protruding member.

5. The conveyor system of claim 2, wherein when the cam is in the second position, the first protruding member of each flight engages a second surface of the first groove such that, in use, each flight rotates in a second direction about its first protruding member.

6. The conveyor system of claim 2, wherein the second groove defines a path shorter than the first groove.

7. The conveyor system of claim 2, wherein the control system is a pneumatic drive system.

8. The conveyor system of claim 2, wherein the control system is a servo motor.

9. The conveyor system of claim 2, wherein the second groove extends laterally from the first groove, and wherein the first and second guiding members laterally protrude different lengths from the indexing flights such that only the second protruding members engage with the second groove.

10. The conveyor system of claim 2, wherein the adjustment means comprises a control apparatus for directing pressurised gas towards each flight so as to adjust the first protruding member of each flight to a leading or trailing position with respect to its second protruding member such that each flight is positioned in either a protruding position or a retracted position with respect to the conveyor.

11. The conveyor system of claim 2, wherein the adjustment means comprises magnets for adjusting the first protruding member of each flight to a leading or trailing position with respect to its second protruding member such that each flight is positioned in either a protruding position or a retracted position with respect to the conveyor.

12. The conveyor system of claim 2, further comprising a tray guide located along the conveyor for supporting an article being conveyed.

13. The conveyor system of claim 12, wherein the tray guide has third and fourth grooves for receiving the first and second guiding members respectively, wherein the fourth groove laterally extends from the third groove, and the third and fourth grooves cooperate with the first and second grooves respectively.

14. The conveyor system of claim 13, wherein the third and fourth grooves each define a path parallel to the conveyor.

15. The conveyor system of claim 2, further comprising a static cam laterally adjacent the conveyor having fifth and sixth grooves for receiving the first and second guiding members respectively, wherein the sixth groove extends laterally from the fifth groove and the fifth and sixth grooves cooperate with the third and fourth grooves respectively.

16. The conveyor system of claim 15, wherein the sixth groove defines a path shorter than the fifth groove.

17. The conveyor system of claim 15, wherein the third and fifth grooves define a single continuous groove and the fourth and sixth grooves define a single continuous groove.

18. The conveyor system of claim 2, wherein the first guiding member of each flight has a substantially circular cross section.

19. The conveyor system of claim 18 wherein the first guiding member of each flight further comprises an O-ring.

20. The conveyor system of claim 2 wherein the conveyor is an endless conveyor.

21. The conveyor system of claim 20, wherein the conveyor is an endless chain.

22. The conveyor system of claim 21, wherein the chain engages with a drive sprocket and an idler sprocket.

23. The conveyor system of claim 22, wherein each of the indexing flights are coupled to extended chain pins.

24. The conveyor system of claim 22, wherein the moveable cam is laterally spaced from the idler sprocket.

25. The conveyor system of claim 2, wherein each flight has a curved portion for travelling around corners.

26. The conveyor system of claim 2, wherein the first guide member is a drive roller.
